(19) United States
(12) Patent Application Publication
(10) Pub. No.: US 2009/0240072 A1
(43) Pub. Date: Sep. 24, 2009

(54) Mixing Device for Liquids

(75) Inventor: Manuel Buck, Gebenstorf (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/084,423

(22) PCT Filed: Nov. 17, 2006
(86) PCT No.: PCT/EP2006/068617

§ 371 Date: Jun. 3, 2009

(30) Foreign Application Priority Data
Nov. 17, 2005 (EP) 05110886.8

(51) Int. Cl. B01J 19/18; C07F 7/10

(52) U.S. Cl. 556/413; 422/225; 422/105

(57) ABSTRACT

The device serves for mixing at least one liquid first and one liquid, viscous or powdery second component which can be introduced into the mixing chamber of a mixing body and, after the mixing process has been carried out, can be removed again from said mixing chamber in the form of the mixed product. According to the invention, the mixing body is a self-contained annular tube system, the interior space of which forms the mixing chamber through which the mixed product can be transported cyclically by means of a conveying element, wherein a plurality of closeable inlet openings for the feed of the components and at least one closeable outlet opening for the removal of the mixed product are provided in the mixing body. The device is suitable for the admixing of reactive components. In particular, it is suitable for the production of aqueous silanes.

### FIELD OF THE INVENTION

The invention starts from a device for mixing a liquid first component and at least one liquid or non-liquid further component according to the preamble of the first claim. In particular, the invention starts from a mixing device which is cleaned after use and is reused with all its elements.

### PRIOR ART

Mixing devices by means of which two or more components are mixed to give a completely or partly mixed product are used in various industrial sectors, for example in the adhesives industry.

Static mixers in which the mixing is effected by repeated division of the mixed product and dynamic mixers in which the mixed product is repeatedly divided or fluidized by means of a moving element are known.

Static mixers, which have no driven elements (cf. e.g. [1], WO 02/32562 A1), are suitable in particular for mixing substances having a low viscosity.

[2], U.S. Pat. No. 4,191,480 discloses a static mixer by means of which solids can be mixed with liquids. After the passage of the components to be mixed through this static mixer, a mixed product is formed, the thorough mixing of which can be improved only by means of the use of further mixing devices. In order to achieve a desired mixing ratio, the flows of the components fed in must also be precisely adjusted.

[3], U.S. Pat. No. 4,264,212 discloses a further static mixer which is suitable in particular for mixing building material components. In this static mixer, a liquid component, for example water, is passed through a tube element which has, in the direction of flow, firstly a divergent and then a convergent part. The divergent part of the tube element is connected to feed lines through which the further liquid or solid, for example pulverulent, components to be mixed can be fed. This mixing device therefore has a particularly simple design but does not permit sufficiently homogeneous mixing of the components as is required for various applications.

[4], U.S. Pat. No. 5,240,327 and [5], U.S. Pat. No. 6,024,481 discloses dynamic mixers which serve for mixing liquids and which have a mixing chamber in which mixing elements held by a drive axle are moved. [6], US 2004/0190372 A1 discloses a dynamic mixer having a mixing pocket which is present in a container and in which liquids are thoroughly mixed by means of a magnetic stirring bar. In the case of these large-volume mixing devices, sufficiently good mixing is achieved only after a relatively long duration of mixing.

In order to avoid contamination of the mixing components, it is necessary according to [6] that the parts of the mixing device which come into contact with the mixed product are thoroughly cleaned before the mixing device is put into operation. This is scarcely possible in the case of the mixing devices which are described in [4] and [5] and which have substantially closed mixing chambers. In the case of the mixing device shown in [6], the cleaning is simpler. However, owing to the use of a mixing pocket, the overall mixing device is substantially more complicated in design.

In the mixing of a plurality of components, the precise metering thereof is moreover of importance, which is possible in the case of the devices described above only by means of relatively complicated metering measures and/or metering devices.

Furthermore, the mixing devices described can scarcely be used flexibly. Thus, it is scarcely possible to use these mixing devices in exposed areas, for example on scaffolding.

Moreover, a relatively large amount of space is required for the storage and the transport of the mixing devices described.

If reactive components are employed, it is known that the procedure is effected in high dilution for preventing oligomers, such as, for example, by slow dropwise addition of a highly dilute component with vigorous stirring to a likewise highly dilute second component. However, it is possible in this way to prepare only low concentrations of desired substances and it is therefore necessary to concentrate many times again, for example by distilling off solvent, which means an additional effort and therefore also entails an increase in the production costs.

### SUMMARY OF THE INVENTION

It is the object of the invention to provide an improved mixing device of the type stated at the outset.

In particular, the mixing device according to the invention should permit easy and precise metering of two or more components and the rapid and homogeneous mixing thereof to a degree specified by the user.

Furthermore, the mixing device according to the invention should have a simple design, be economically producible and capable of flexible use and should be simple to operate and capable of being cleaned and maintained with only little effort. Compact, easily transportable, in particular portable, devices can be realized.

Furthermore, the mixing device according to the invention should occupy only a little space for storage and transport.

According to the invention, this object is achieved by the features of the first claim. Further advantageous configurations of the invention are evident from the subclaims.

The device according to the invention serves for mixing a first liquid component and at least one liquid, viscous or pulverulent further component, which can be introduced into the mixing chamber of a mixing body and, after the mixing process has been carried out, can be removed therefrom again in the form of a mixed product.

In the entire present document, the designation “mixed product” (abbreviated to “MP”) is understood as meaning a product which results from the mixing of the components K1, K2 and optionally further present components K3, K4, . . . etc. In particular, it also comprises reaction products which result during the mixing of these components.

According to the invention, the mixing body is a self-contained, preferably annular, tube system whose interior forms the mixing chamber through which the mixed product can be transported cyclically by means of a conveying element.

Provided in the mixing body are a plurality of inlet openings through which the components to be mixed can be fed. Furthermore, at least one outlet opening from which the mixed product can be removed is provided. The inlet openings and the outlet opening, optionally also an additionally provided overflow opening, may be closable by means of manually or automatically actuated mechanical or electromechanical valves. For example, a conventional tap or an electromechanical valve which is actuated by means of a control unit can be provided at the outlet opening. The inlet valves may have outlet openings with sealing elements which rest against said openings and are resilient or pressed elastically against said openings and which are displaced under pressure of a component fed in, so that the component can flow through the outlet openings into the mixing chamber; on the other hand, back-flow is prevented. An inlet opening can also be assigned two valves, of which the first valve controls the feed of a component and the subsequent second valve merely prevents the back-flow of the mixed product.

The mixing device according to the invention offers various particularly simple possibilities for metering the components to be mixed, it being necessary to note that a resulting filling with components is required which permits the mixed product to circulate in the mixing chamber. The advantages of the invention are particularly pronounced in particular when only a few percent by volume of one or more further components are fed into a first component. The main possibilities for metering the components are the following.

For example, the mixing chamber is only partly filled with the first component, after which the further components are fed in. The metering can be effected before the components are fed in, for example by means of gravimetric or volumetric methods, or during the feeding of the components, for example by means of measuring devices, with which the level of fill of the mixing chamber is monitored. The use of a metering chamber into which the components are introduced in a controlled manner, for example by means of measuring devices or by means of metering pistons, optionally by means of piston pumps, and then transferred to the mixing chamber is possible.

Preferably, however, the mixing chamber is completely filled with the first component, after which the volume of the mixing chamber is changed or a certain volume fraction of the first component is removed from the mixing chamber and the volume fraction which has become available is filled with one of the further components. In this case, the mixing chamber itself therefore serves as a metering unit, so that only one further device for metering the further components is required. For example, metering bodies, metering screws or metering cylinders can be provided in the mixing chamber and are pushed out of the latter to the required extent to create the desired volume fraction. The use of a vessel into which the corresponding volume fraction of the first component is introduced through the outlet valve or an overflow valve is possible. The use of a measuring sensor which detects the level of fill within the vessel and outputs a corresponding electrical signal to a control unit which controls a valve by means of which the inlet opening of the expansion vessel can be closed is also possible.

The use of a metering body having a metering chamber which, after filling with a second or further component, can be transferred into the mixing chamber which is filled with the first component and in which the metering chamber is picked up by the first component and circulated through the mixing chamber.

As mentioned above, the mixing chamber itself can be used as a metering unit since it has a known volume. It is now possible to assemble the mixing body from various elements, in particular tube elements and connecting devices, which are chosen so that a desired volume of the mixing chamber results. The use of adjustable tube elements, by means of which a desired volume can be established, for example by pushing one into the other, is furthermore possible.

The mixing device according to the invention can therefore have an integral design or a modular design comprising a plurality of tube system parts which can be connected to one another and are preferably provided in various sizes so that the mixed product can be produced with the desired volume. Angle elements and straight tube elements are preferably provided. The straight tube elements can be particularly easily provided with the inlet, outlet and/or overflow openings, optionally the metering bodies, the static mixer and/or the conveying element. The use of a single tube section which is provided with all substantial functional elements of the mixing device and which can be connected to a flexible hose-like or rigid or hard resilient tube-like supplementary piece in such a way that a closed, annular mixing chamber is formed is particularly advantageous.

For connecting the tube system parts, for example, annular flanges which can preferably be screwed to the straight tube elements are provided. After the mixing device has been used, it can be dismantled and cleaned in a simple manner and stored and transported in small storage spaces. If a plurality of straight tube elements is provided, they are preferably provided with different diameters so that they can be pushed one into the other. The use of extensible tube elements, such as bellows elements, by means of which the volume of the mixing chamber can be adjusted, is furthermore possible.

The conveying element provided, which serves for conveying and circulating the mixed product, may be of various designs and may be driven in various ways. It can be arranged in the mixing chamber or outside the mixing chamber.

In one embodiment, the conveying element in the form of a peristaltic pump acts from the outside by means of a peristaltic force on a region of the tube system which is resilient at least in the region of the peristaltic pump. The peristaltic force is usually transmitted by rotating rollers to the tube system, which here is typically in the form of a hose. As a result, the tube is squeezed. As a result of the movement of the rollers in the direction of flow, the mixed product is advanced in the direction of flow. After relief of the tube by removal of the peristaltic force, the internal cross section of the tube increases again so that the mixed product in this region can continue flowing in the direction of flow.

In a preferred configuration, the conveying element, which has, for example, the form of a screw or of a propeller, is rotatably held by means of a shaft so that it can be rotated by rotation of the shaft or by direct magnetic action on the conveying element. For example, the shaft rigidly connected to the conveying element can be rotated manually or by means of an electric motor. Furthermore, the conveying element can also be moved forward and backward axially in order to convey the mixed product. For this purpose, the conveying element has, for example, wing or bucket elements which are held by means of a joint and open or close as a function of the direction of movement.

Furthermore, the conveying element can be provided with permanent magnets on which an external magnetic field acts in order to rotate the conveying element in the mixing chamber or to move said conveying element forward and backward. There is therefore no mechanical intervention in the mixing chamber, and corresponding device parts and sealing elements are therefore omitted.

The external magnetic field can be generated by means of coils of a drive unit or by means of permanent magnets which are arranged on a magnet holder which encloses the mixing device preferably in an annular manner. By rotation, displacement or switching of the external magnetic field, for example by changing the currents in the coils or drive unit or by displacing or rotating the magnet holder, the conveying element can be correspondingly moved.

The conveying element preferably serves not only for conveying but also for thoroughly mixing the mixed product. The mixed product can be circulated until a desired thorough mixing of the components is achieved. Since the correspondingly designed conveying element can detect and fluidize the total stream of the mixed product, a particularly efficient mixing process can be realized.

The conveying element can serve as a dynamic mixer which fluidizes and mixes the components to be fed in. It is of course also possible to achieve substantially laminar conveying of the mixed product. This is strived for, for example, if the properties of the components require this and/or if the mixing chamber is additionally provided with at least one static mixer through which the mixed product is passed cyclically during the mixing process. Preferably, however, the mixing device according to the invention simultaneously operates as a dynamic and static mixer, with the result that optimum efficiency is achieved.

For rapid and complete emptying of the mixing chamber after the end of the mixing process and after opening of the outlet opening, a gaseous medium, in particular air or an inert gas, such as nitrogen, can be let into the mixing chamber through one of the inlet openings, by means of which gaseous medium the mixed product is ejected under pressure through the outlet opening. In the same operation, the finished mixed product can also be applied.

The mixing body or the elements thereof preferably consist of optionally coated material, such as plastic or metal, which is inert with respect to the components to be mixed and the resulting mixed product.

The geometry of the mixing body can be variously chosen. For example, the mixing body may be round or rectangular. The geometry of the mixing body should advantageously be chosen so that all regions of the mixing chamber and of the parts projecting into the mixing chamber are thoroughly flushed and in particular no regions form around which no circulation takes place or circulation takes place only poorly.

The operation of the device can be effected completely manually or in a partly or completely automated manner.

The device can be very compact and can be realized in dimensions of less than 2 m, in particular of less than 1 m, length, width and height. Such devices can also be constructed to be light, i.e. easily transportable, in particular portable, i.e. less than 30 kg, in particular less than 20 kg, preferably less than 10 kg.

It has been found that the device according to the invention can be used in particular for mixing reactive components. It is particularly suitable for the components K2 which react with the component K1 or, under the influence of the component K1, with themselves. The device has proved to be particularly suitable for the preparation of aqueous silanes in which the component K1 comprises water or consists thereof and the component K2 comprises a silane or consists thereof. It has been found in particular that the formation of undesired higher molecular weight oligomers or reaction products can be prevented or at least greatly reduced by this method.

### BRIEF DESCRIPTION OF THE DRAWING

Below, working examples of the invention are explained in more detail with reference to the drawings. Identical elements are provided with the same reference numerals in the various figures. Only the elements essential for the direct understanding of the invention are shown. The direction of flow of the media and the directions of rotation are indicated by arrows.

FIG. 1 shows a mixing device 1 according to the invention, comprising a mixing body 10 which is provided with inlet openings 101, 102, 103 and an outlet opening 109 and which comprises a mixing chamber 100 in which the components to be mixed are circulated and thoroughly mixed by means of a conveying element 7 which is driven by means of a magnetic drive 70;

FIG. 1a shows a sectional diagram of a valve 53 which is used in the inlet opening 103 shown in FIG. 1;

FIG. 2 shows the mixing device 1 of FIG. 1 with a manually actuatable mechanical drive device 75, 750 for the conveying element 7″ and with preferably designed valves 51, 52, 53 and a vent screw 5000;

FIG. 2a shows the valve 51 of FIG. 2, whose valve body 500 provided with outlet openings 501 is enclosed by a resilient hose 5031 which opens the outlet openings 501 under pressure;

FIG. 2b shows the valve 52 of FIG. 2, whose valve body 500 is enclosed by a resilient cap 5032 which has an extensible outlet opening 50321;

FIG. 3 shows the mixing device 1 of FIG. 1 with an electrical drive 70 for the conveying element 7″ and metering devices, such as metering bodies 81A, 81B, and expansion vessels 8;

FIG. 4 shows the mixing device 1 of FIG. 3 with two metering screws 81A and a pressure relief valve 510;

FIG. 5a-c show a metering chamber 1000 with valves 52d, 53d and metering devices 4, 81B;

FIG. 6 shows a metering device provided with three inlet lines 92, 900, 901 and having a metering drum 3 which is provided with a metering chamber 31 which is rotatable into the mixing chamber 100;

FIG. 6a shows the metering device of FIG. 5 with three outlet lines;

FIG. 6b shows the metering device of FIG. 5 with one outlet line;

FIG. 7 shows the mixing device 1 of FIG. 1 with a first tube element 111 which can be connected to various second tube elements 112;

FIG. 8 shows the mixing device 1 of FIG. 1 with electrically controlled valves 51′, 52′, 53′ which are coupled to mechanical non-return valves 51, 52, 53;

FIG. 9 shows the conveying element 7 of FIG. 1 which is provided with permanent magnets and that is driven by means of a rotating field induced by coils;

FIG. 10 shows the rotatably mounted conveying element 7 of FIG. 1 which is provided with permanent magnets and that is coupled to a rotatable external magnet holder 7000;

FIG. 11 shows the conveying element 7 of FIG. 1 which is provided with permanent magnets and is mounted so as to be axially displaceable and that can be displaced by means of coils 700A, 700B between a first and a second position;

FIG. 12 shows the conveying element 7 of FIG. 1 which is provided with permanent magnets and is mounted so as to be axially displaceable and that is coupled with an axially displaceable external magnet holder 7000′; and

FIG. 13 shows a mixing device 1 according to the invention, comprising an annular mixing body 10 which has a straight tube element 111 with all functional elements of the mixing device 1 and an additional flexible or rigid supplementary element 112 or 112′.

### DESCRIPTION OF THE PREFERRED EMBODIMENTS

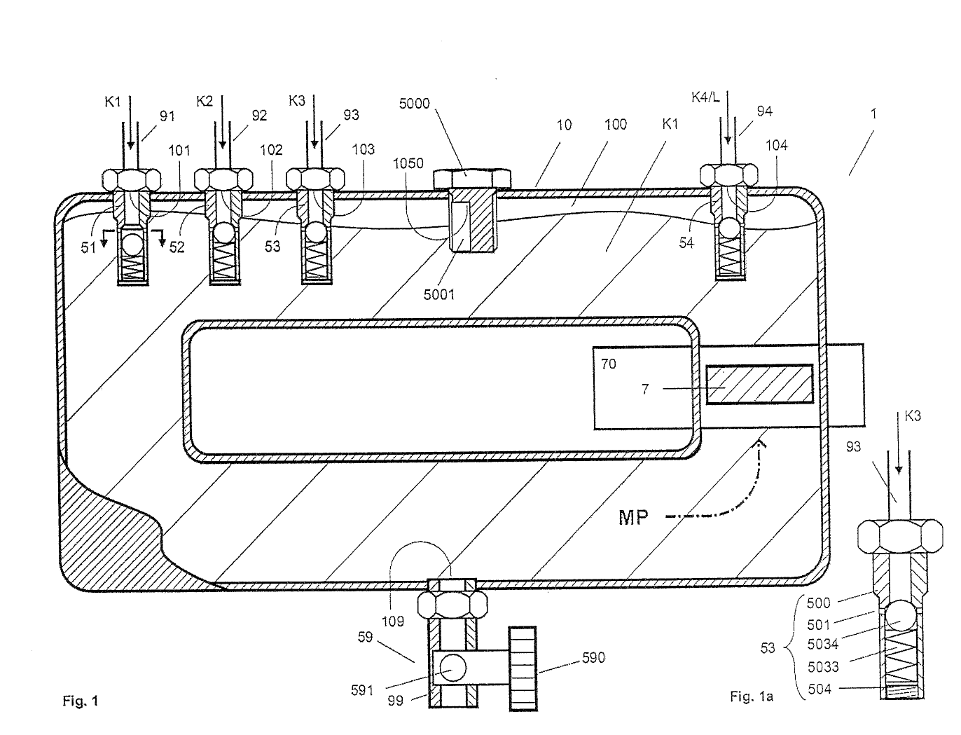

FIG. 1 shows a mixing device 1 according to the invention, comprising a simply designed annular mixing body 10 whose interior forms the mixing chamber 100 through which a mixed product MP can be transported cyclically by means of a conveying element 7. The top of the mixing body 10 is provided with a plurality of closable inlet openings 101, 102, 103, 104 through which components K1, K2, K3 and K4 to be mixed, which are conveyed in lines 91, 92, 93 and 94, can be introduced into the mixing chamber 100. A closable outlet opening 109 from which the finally processed mixed product MP can emerge into an outlet line 99 is provided on the bottom.

The inlet openings 101, 102, 103 are provided with non-return valves 51, 52, 53 which prevent the mixed product MP from being able to flow back into the feed lines 91, 92, 93, 94 of the components K1, K2, K3, K4. Furthermore, a vent screw 5000 having a vent channel 5001 is provided in an opening 1050, through which air can escape from the mixing chamber 100 when the components K1, K2 to be mixed are introduced. The outlet opening 109 is closed by a manually actuatable valve or tap which, in the simplest design, consists of a shaft rotatable by means of a wheel 590 and having a passage 591 which is rotatable into the outlet channel.

In this particularly simple design of the mixing device 1, the components K1, K2, . . . can be introduced under pressure into the mixing chamber 1, thoroughly mixed after the drive device has been put into operation and then removed in the form of the mixed product MP through the outlet valve 59 and the outlet line 99. The annular mixing body 10 can of course have any desired other shapes and may be, for example, circular, oval or elliptical.

FIG. 1a shows the structure of the non-return valve 53, which has a valve body 500 with an axial bore and outlet openings 501 which can be closed by means of a ball 5034 which is pressed upward by a resilient element or a metal spring 5033 which rests on an insert element 504.

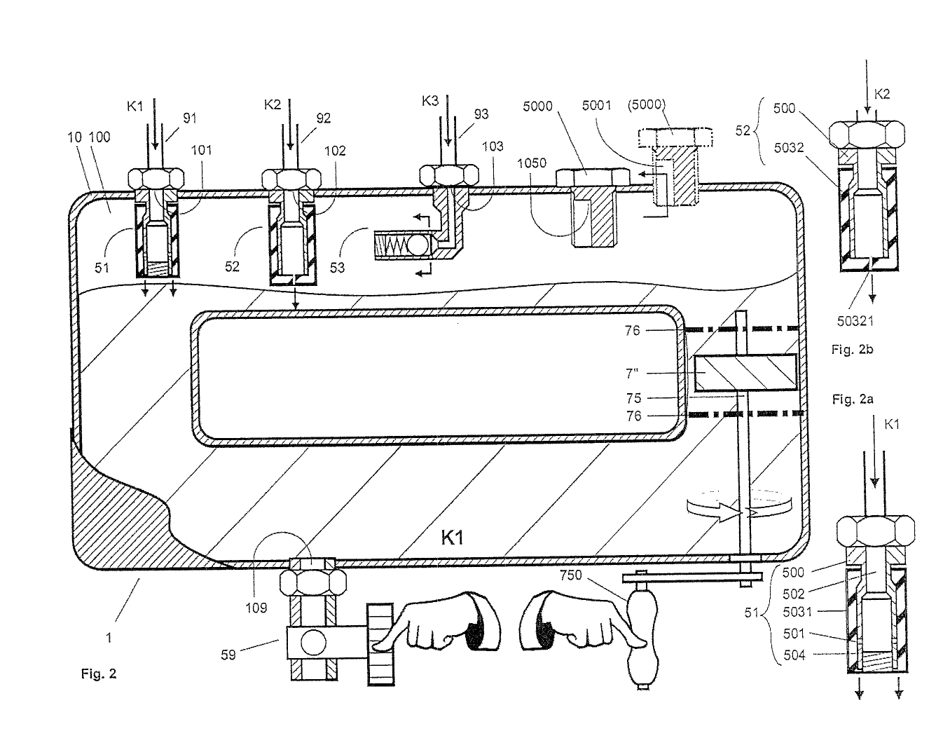

FIG. 2 shows the mixing device 1 of FIG. 1 with a manually actuatable mechanical drive device 75, 750 for the conveying element 7″ which is held by a shaft 75 which is mounted at two ends and can be manually driven by means of a crank 750.

FIG. 2 furthermore shows valves 51, 52 which have a preferable design and through which the components K1, K2 can be introduced into the mixing chamber 100. The various valves are of course shown only by way of example. Usually, as far as possible standard valves are used.

FIG. 2a shows the valve 51 whose valve body 500 provided with outlet openings 501 is enclosed by a resilient hose 5031 which opens the outlet openings 501 under the pressure of the first component K1 fed in and then closes them again so that the mixed product MP cannot penetrate into the line 91.

FIG. 2b shows the valve 52 whose valve body 500 is enclosed by a resilient cap 5032 which has an extensible outlet opening 50321, which is widened under the pressure of the second component K2 fed in, allows said component to pass through and then closes again so that the mixed product MP cannot penetrate into the line 91.

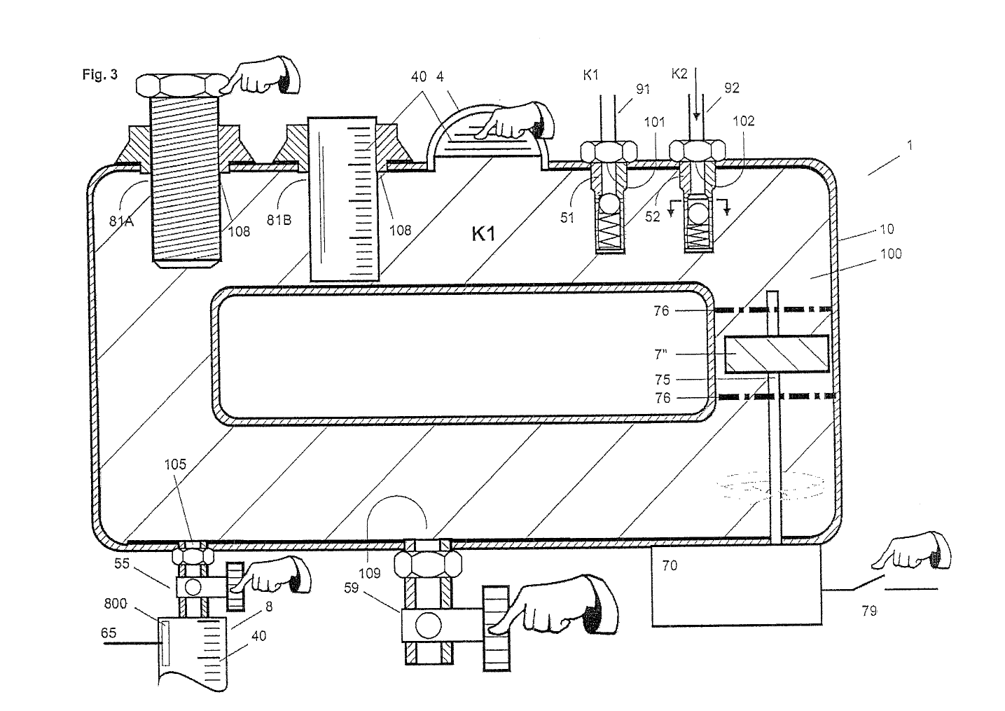

FIG. 3 shows the mixing device 1 of FIG. 1 having an electrical drive 70 for the conveying element 7″. The shaft 75 provided with the conveying element 7″ is driven by means of an electric motor 70 which is switched on and off by means of a switch 79. Preferably, the shaft 75 is mounted inside the mixing chamber 100 by means of bearing elements 76 so that it emerges from the mixing body 10 only on one side and has to be provided with sealing elements there.

FIG. 3 furthermore shows metering devices, such as metering bodies 81A, 81B, by means of which the (free) volume of the mixing chamber 100 is adjustable, and an expansion vessel 8 into which the component K1 can be discharged with metering. A level indicator 4, by means of which the level of fill can be precisely read, is furthermore shown.

The mixing of two components, a liquid first component K1 and a liquid, viscous or pulverulent second component K2, takes place by means of the mixing device 1 of FIG. 2 as follows.

Firstly, the components K1, K2 to be mixed can be introduced with metering into the mixing chamber 100 and mixed there. This can be effected in the traditional manner by gravimetric or volumetric metering, which is possible with a known effort. Alternatively, the level of fill can be read on the graduated scale 40 on the level indicator 4 and the second component K2 can be fed in until an appropriately calculated level of fill is reached.

However, this effort can be substantially avoided by means of the mixing device 1 according to the invention if, in a first step, the mixing chamber 100, which has a known volume, is completely filled with the first component K1, for example water. A space for the second component K2 is then created in the mixing chamber 100. For example, a certain volume of the first component K1 is removed through the manually actuatable valve 55 into the first expansion vessel 8 or discharged through the outlet opening 109. Alternatively, the metering screw 81A or the piston 81B can be screwed out of, or withdrawn from, the mixing body 10 until the volume fraction intended for the second component K2 is released. If air cannot flow into the volume which has become available, the second component K2 is automatically sucked into the mixing chamber 100 by the resulting vacuum. For example, exactly 5 ml of the second component K2 are introduced into the mixing chamber 100 with each revolution of the metering screw 81A.

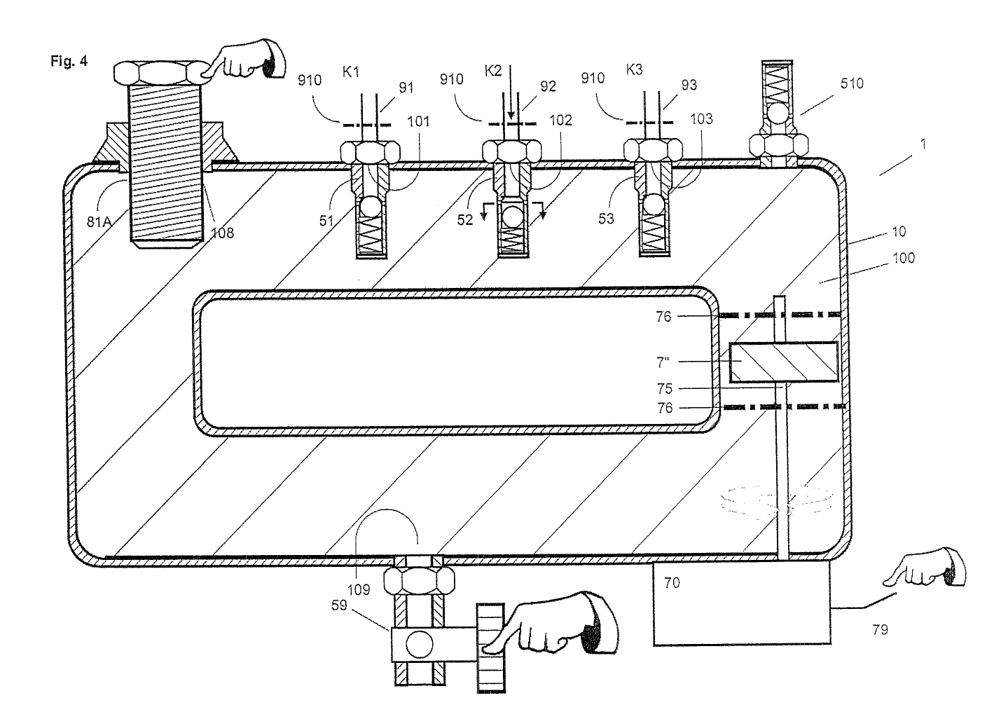

The metering is effected in a particularly simple manner using the mixing device 1 which is shown in FIG. 4 and has three inlet valves 51, 52, 53, a metering screw 81A and a pressure relief valve 510. The feed lines to the inlet valves 51, 52, 53 or these themselves can be closed by means of closing devices 910, 920, 930. In a first step, after the opening of the first closing device 910, the mixing chamber 1 is filled with the first component K1 (e.g. water) until this emerges from the pressure relief valve 510, i.e. until the mixing chamber 100 is completely filled with the first component K1. In a second step, the first closing device 910 is closed again, the second closing device 920 is opened and the metering screw 81A is rotated n revolutions out of the mixing chamber 100, with the result that a corresponding volume of the second component K2 is automatically sucked into the mixing chamber 100. In a third step, the second closing device 920 is closed again, the third closing device 930 is opened and the metering screw 81A is rotated m revolutions out of the mixing chamber 100, with the result that a corresponding volume of the third component K3 is automatically sucked into the mixing chamber 100. The drive device is preferably put into operation after introduction of the first component K1 so that the further components are admixed continuously.

The mixed product MP is now circulated through the mixing chamber 100 until the desired degree of mixing occurs. The total mixed product MP is thus included in the mixing process with each cycle so that the degree of mixing strived for is achieved with high efficiency and in a minimum time.

After the end of the mixing process, the outlet opening 109 or the outlet valve 59 is opened and the finished mixed product MP is discharged from the mixing chamber 100. The discharge or the release of the mixed product MP is preferably effected under the action of the pressure of a gaseous medium L, such as air, which is introduced into the mixing chamber 100, for example, through one of the inlet openings (cf. FIG. 1, valve 54). The mixed product MP emerging from the mixing chamber 100 under the pressure of the gaseous medium L can be temporarily stored or applied immediately.

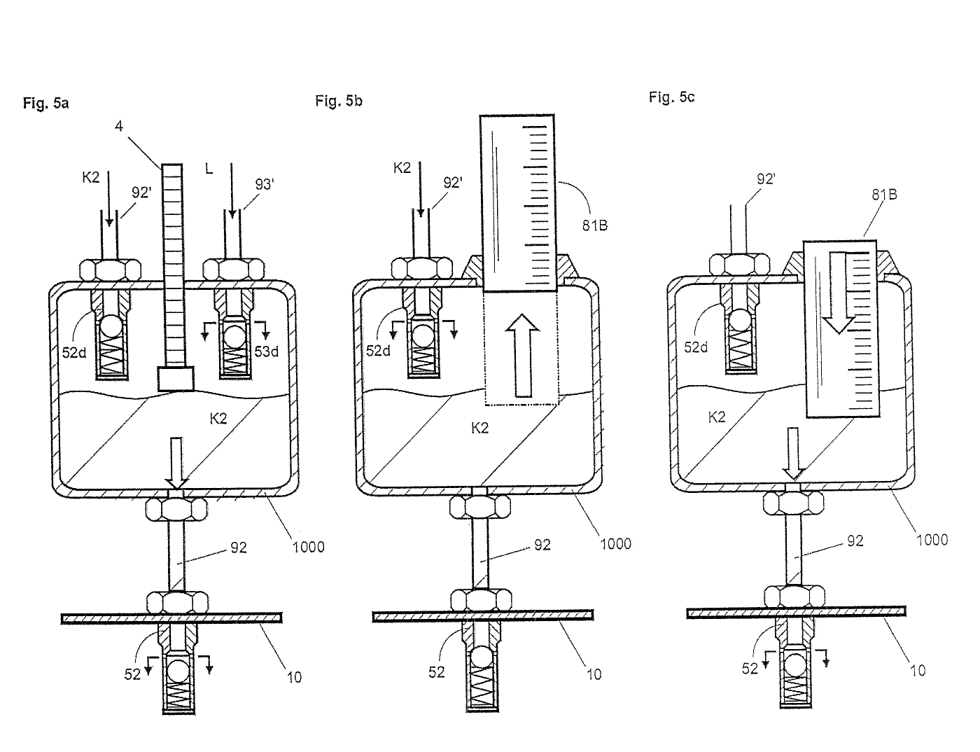

FIGS. 5a, 5b and 5c show metering devices which make it possible to provide a selectable volume of the second component K2 in a mixing chamber 1000.

In FIG. 5a, the component K2 is introduced into the metering chamber 1000 and the level of fill is measured by means of a graduated rod 4 which is held by a float. After the desired level of fill has been reached, the metered volume of the component K2 is transferred via the connecting line 92 into the mixing chamber 100 by forcing air through the valve 53d into the metering chamber 1000. In certain cases, gravimetric transfer is also possible.

In FIG. 5b, the component K2 is sucked into the metering chamber 1000 through the valve 52d by removing a metering piston 81B to a certain extent from said metering chamber. In FIG. 5c, the metering piston 81B is returned, with the result that the valve 52d closes, and the metered volume of the component K2 is transferred into the mixing chamber 100 via the connecting line 92.

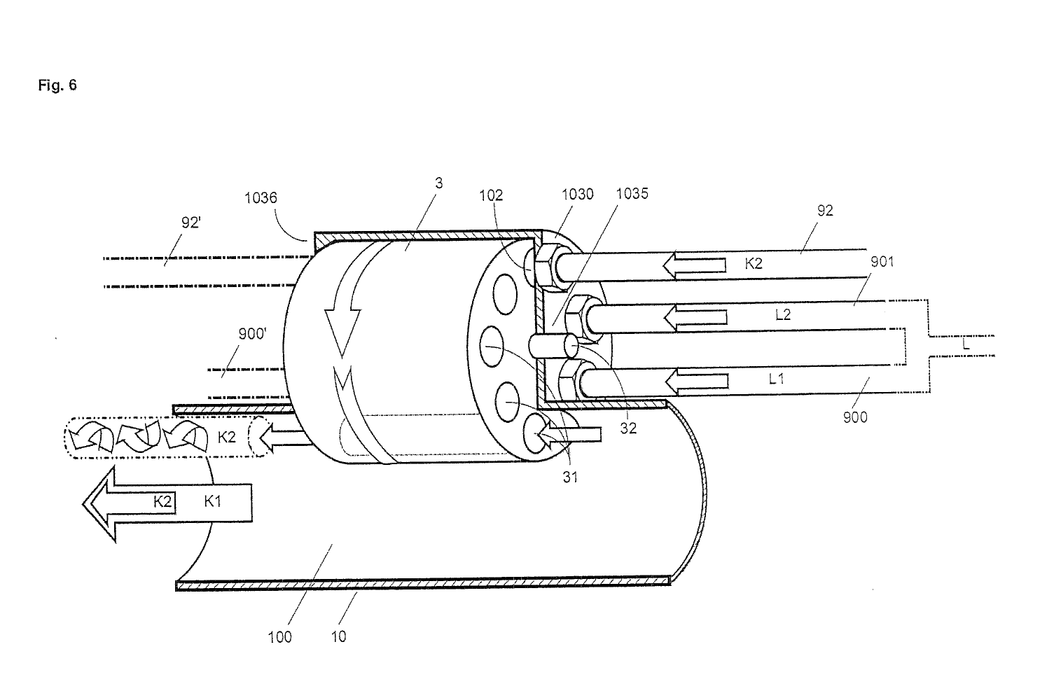

FIG. 6 shows a metering device provided with three inlet lines 92, 900, 901 and having a drum chamber 1030 in which a metering drum 3 is rotatably mounted by means of a shaft 32. The metering drum 3 has a plurality of metering chambers 31 which are rotatable, for example, by rotation of the shaft 32 into the mixing chamber 100 (shown in FIG. 6). In this configuration, the drum chamber 1030 is an integral part of the mixing body 10 and has, at the bounding plates 1035, 1036, only inlet and outlet openings 102 through which, in certain drum positions, a medium can be transferred into the metering chamber 31 or transferred out of the metering chamber 31. The bounding plates 1035, 1036 and optionally provided sealing elements ensure that the media fed in can enter only the metering chamber 31 and the mixed product MP cannot also emerge from the mixing chamber 100. The use of one or more metering chambers 31 is possible

The metering device of FIG. 6 functions as follows. In a first position, one of the metering chambers 31 is connected to the first inlet line 900 and the outlet line 900′ through which a flushing composition, optionally air, is fed in order to empty and to flush the metering chamber 31. In an optionally provided second position, the metering chamber 31 is connected to the second inlet line 901 through which a gaseous medium L, optionally air or nitrogen, is fed in order to dry the metering chamber 31. In a third position, the metering chamber 31 is connected to the inlet line 92 which carries a component K2 which is to be mixed and which is introduced either only into the metering chamber 31 or is fed through the latter to an outlet line 92′. Furthermore, the metering chamber 31 can be rotated into the mixing chamber 100, in which it is flushed by the first component K1. Thereafter, the metering chamber 31 now filled with the first component K1 is rotated further into the first position where the first component K1 is ejected from the metering chamber 31. The filling and emptying of the metering chamber 31 is now effected until the full metering is achieved. If a plurality of metering chambers 31 is provided, the process described takes place during one rotation of the metering drum 3 sequentially for each metering chamber 31. Of course, it is also possible to provide fourth and further positions at which further components can be received. It is of course also possible for all components to be fed in sequentially via the same line 92.

This device having the metering drum 3 can advantageously be automated by driving the shaft 32 of the metering drum 3, for example, by means of a controlled electric motor.

To enable the metering drum 3 to be manually gripped and rotated, the drum chamber 1030 can also be provided with an opening which, however should be sealed at the edges.

FIG. 6a shows the metering device of FIG. 5 with three outlet lines 900′, 901′ and 92′. For example, the lines 900, 900′; 901, 901′ and 92, 92′ can each be part of a closed circulation.

FIG. 6b shows the metering device of FIG. 5 with only one outlet line 900′ through which the liquid received from the mixing chamber 100 is removed. The air fed in from the second line 901 is on the other hand released to the environment through an opening 10361. In the third position, the metering chamber 31 is closed on one side by the bounding plate 1036.

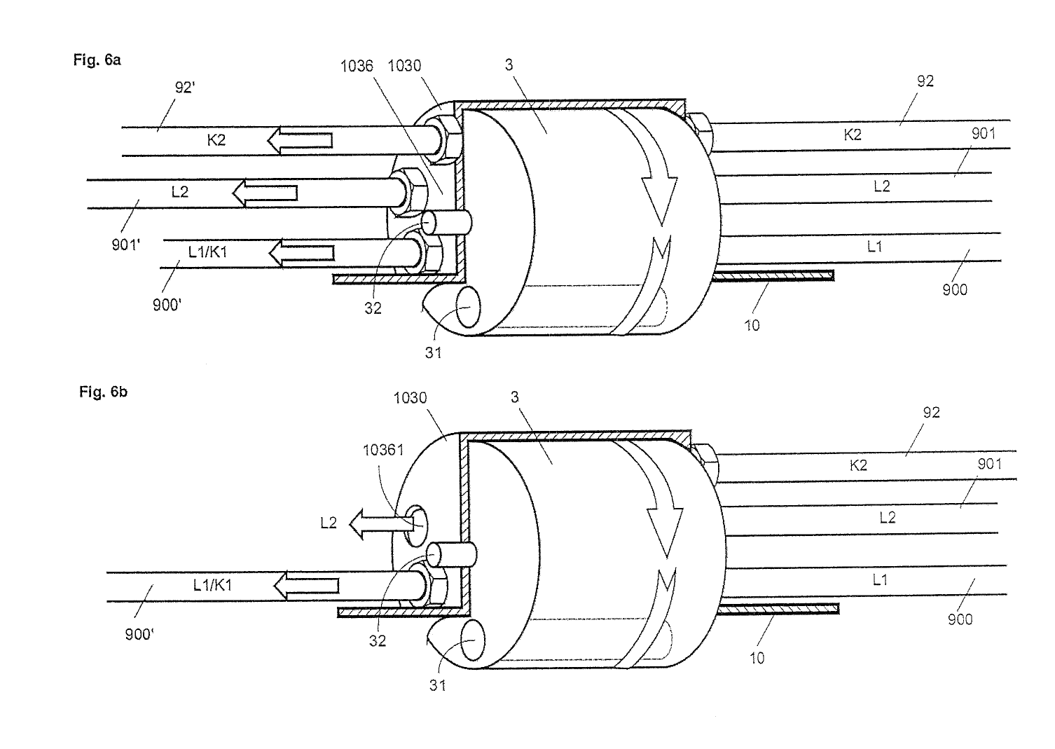

The annular mixing body 10 may consist of one or more parts. FIG. 7 shows the mixing device 1 of FIG. 1 with a first tube element 111 which can be connected to various second tube elements 112 by means of connecting elements 110. For example, a hose-like, flexible second tube element 112A can be connected to the first tube element 111. Furthermore, it is possible to use tube elements 112B, 112C of different size which are made of metal or plastic and make it possible to establish a certain volume of the mixing chamber 100. The tube elements 111, 112 can also be expandable or otherwise adjustable, for example provided with bellows elements 1120C. Furthermore, it is possible to use tube elements which are to be connected to one another and whose internal and external diameters are tailored to one another and whose ends are provided with internal and external threads corresponding to one another so that they can be screwed together in a simple manner. For individual applications, it may also be sufficient if the tube elements are pushed one into the other, it once again being possible to adjust the volume of the mixing chamber 100 in a selectable manner.

The use of resilient tube elements 111; 112 furthermore permits a defined expansion of the mixing chamber 100 under the pressure of the components K1, K2, K3, . . . fed in. Under pressure, for example, the elastic bellows elements 1120C expand to the required extent. The mixing body 10 can therefore be designed in such a way that the volume of the mixing chamber 100 can be quickly set to a fixed value before the beginning of the mixing process and/or that the volume is adjusted variably to a certain value during the mixing process under the pressure of the components K1, K2, K3 fed in. A hose-like resilient tube element 112A can be expanded, for example, under the pressure of the first component K1 fed in to a certain volume, after which a volume of the second component K2 is fed in under pressure, resulting in a further expansion of the resilient tube element 112A.

The mixing device 1 shown in FIG. 7 is furthermore provided, at the outlet of the first tube element 111, then at the inlet valves 51, 52, optionally with a static mixer 2 by means of which the mixed product MP is either fluidized or is divided into substantially laminar part-streams which are transferred individually from the first into different second cross-sectional segments of the mixing chamber 100. Fluidization is advantageous. By the use of the static mixer 2, the mixing process can be further accelerated.

After the mixing device 1 shown in FIG. 7 has been used, the parts 111, 112 of the mixing body 10 can be detached from one another and cleaned without problems and then stored in a compact manner.

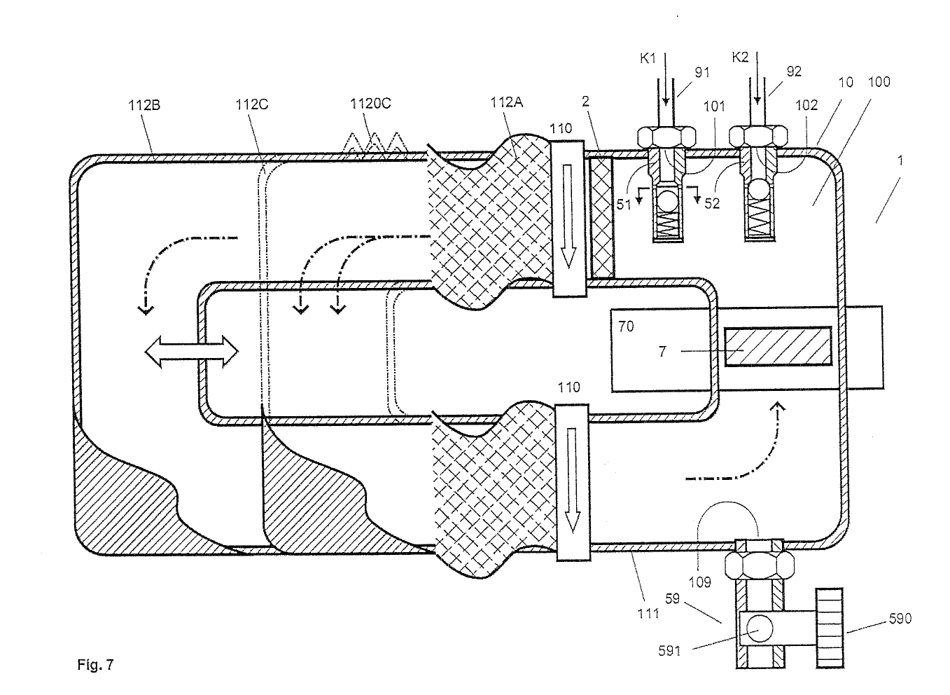

FIG. 8 shows the mixing device 1 of FIG. 1 having electrically controlled valves 51′, 52′, 53′, which are coupled to mechanical non-return valves 51, 52, 53. Only the electrically controlled valve 54′ serving for feeding in air L is not coupled to a non-return valve, so that, for example during filling of the first component K1, the air can escape through the valve 54′. Optionally, an electrically controlled overflow valve 55′ through which liquid can be transferred into a vessel can be provided. The controllable valves 51′, 52′, . . . , 54′ are connected by control lines 61, 62, . . . , 64 to a control unit 6 by means of which it is preferably also possible to control the drive unit 70. The control of the device, in particular the metering, can also be carried out fully automatically by means of the control unit 6. For this purpose, it is preferable to provide measuring sensors 800 (cf. FIG. 3) by means of which, for example, the level of fill of an expansion vessel 8 is measured and the associated valve 55 (cf. FIG. 8) is actuated. Furthermore, the temperature of the mixed product MP can also be measured and optionally a heating element can be controlled.

The valves used for the mixing device 1 can of course also be controllable in another manner, for example pneumatically or hydraulically.

The mixing device 1 of FIG. 8 further has two optionally provided static mixers 2a, 2b which are arranged in the vicinity of the outlet openings of the valves 52, 53 through which the components K2 and K3 are introduced into the mixing chamber 100. This makes it possible to mix the components K2 and K3, after entry into the mixing chamber 100, rapidly into the mixed product.

As described above, the conveying element 7, 7′ mounted so as to be rotatable on or with the shaft 75 or axially displaceable along the shaft 75 is preferably driven by magnetic force.

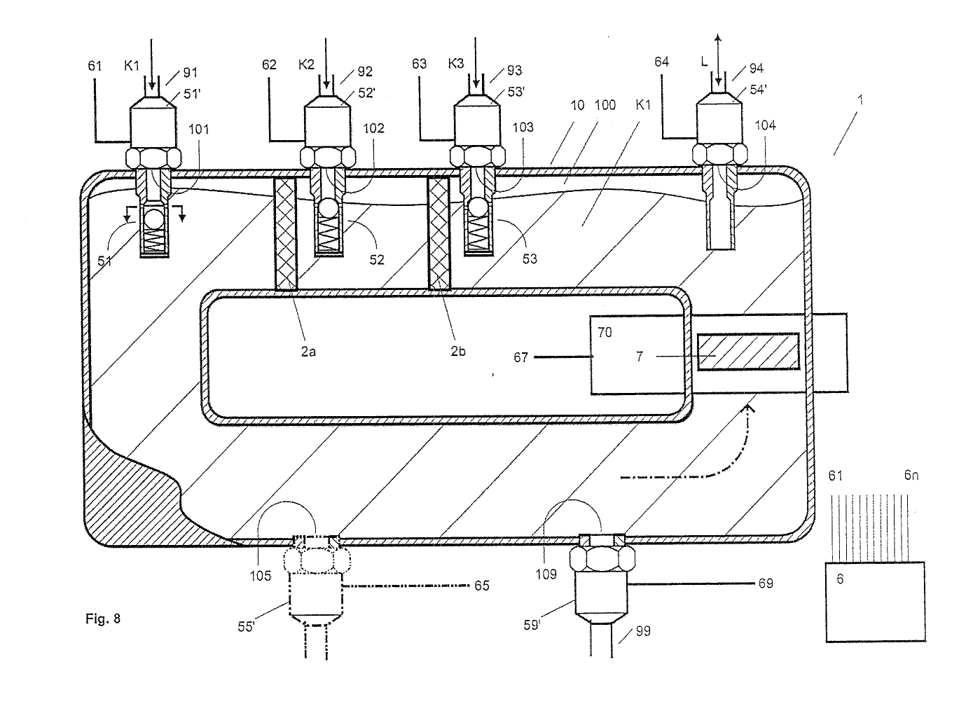

FIG. 9 shows the conveying element 7 of FIG. 1 which is designed as a magnetic rotor and has rigidly arranged wing elements 71 which are held between the shaft 75 and a magnet ring 72 provided with magnets. During the rotation of the magnetic rotor 7, the mixed product MP is conveyed by the wing elements 71 in the direction of flow. The magnets mounted on the magnet ring 72 are produced, for example, from AlNiCo, SmCo or NdFeB. Preferably, high-energy magnets comprising the rare earth metals are used. These materials are distinguished by their high energy product of more than 300 kJ per cubic meter. Of practical importance thereby are materials of the lanthanide group, in particular samarium-cobalt (SmCo) and neodymium-iron-boron (NdFeB).

By applying an external magnetic field, which is generated, as shown in FIGS. 9, 10, 11 and 12, by means of electrical coils 700 or 700A, 700B or by means of an external magnet holder or of an outer magnet ring 7000, 7000′, the conveying element 7, 7′ can be set into motion.

In FIG. 9, the coils 700 generate a rotating magnetic field which picks up and rotates the conveying element 7 which is in the form of a magnetic rotor and on which the permanent magnets are alternately aligned.

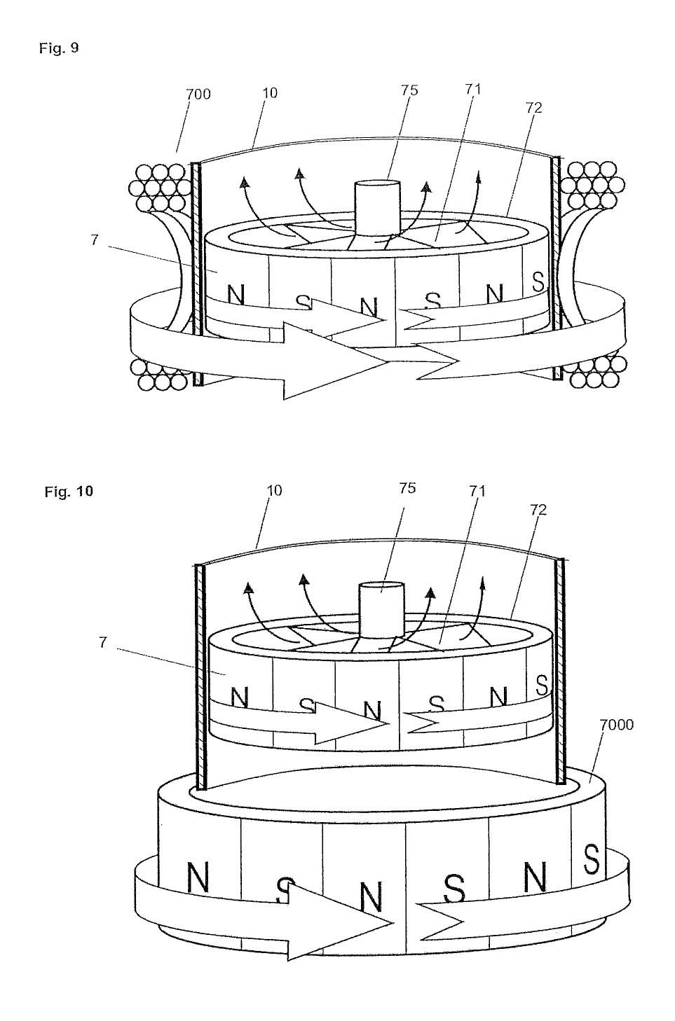

In FIG. 10, an external magnet holder provided with permanent magnets or an outer magnet ring 7000 is provided outside the mixing body 10, which magnet holder or which magnet ring is coupled to the magnetic rotor 7 in such a way that those fields of the permanent magnets of the inner magnet ring 72 and of the outer magnet ring 7000 which are coordinated with one another are aligned in the same direction and amplify one another. The inner magnet ring 72 and the outer magnet ring 7000 are therefore rigidly coupled to one another. If the outer magnet ring 7000 is rotated manually or by means of a motor, the desired rotation of the magnet ring 72 therefore also takes place, after which the wing elements 71 fluidize the mixed product MP and convey it through the mixing chamber 100.

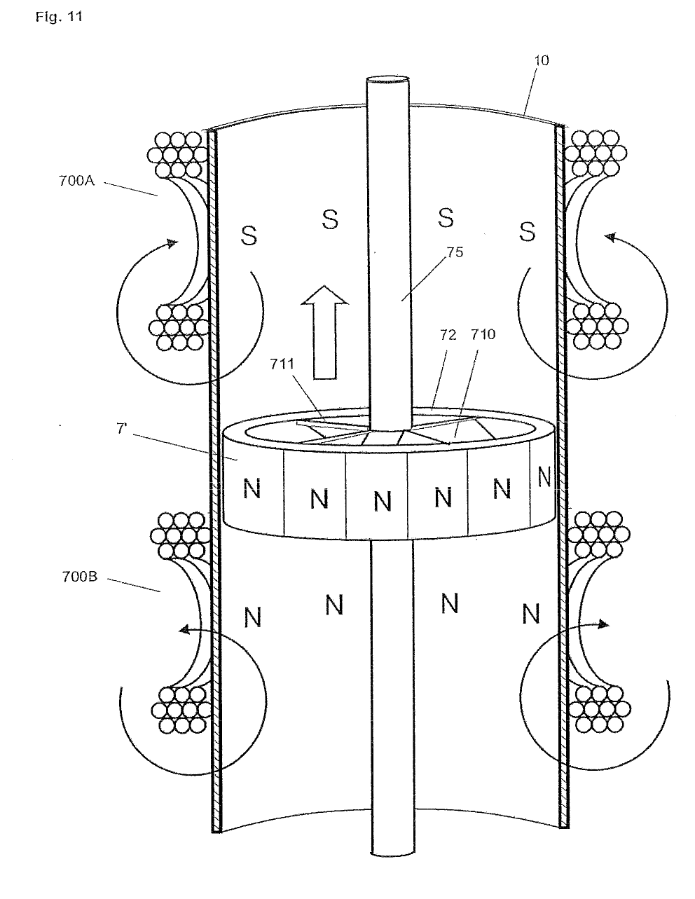

FIG. 11 shows the conveying element 77′ of FIG. 2, which is mounted so as to be axially displaceable, in a further configuration with wing elements 710 which are mounted by means of shafts 711 so as to be rotatable between two positions. In the first position, the wing elements 710 are unfolded and convey the mixed product MP in one displacement direction. In the other displacement direction, the wing elements 710 are folded up so that the mixed product MP can pass unhindered. Alternatively, the conveying element 7′ can also be provided with a screen element which closes on impact with the mixed product MP and opens on being drawn through the mixed product MP. If the conveying element 7′ designed in this manner is now moved forward and backward along the shaft 75, the mixed product MP is always conveyed only in one direction. In this configuration, the inner magnet ring 72 is preferably equipped with permanent magnets of the same radial pole alignment (N—N— . . . ).

If currents are now passed in different directions through the coils 700A, 700B shown in FIG. 11, fields of different polarity are formed, one of which attracts the inner magnet ring 72 in one direction and the other repels said magnet ring in the same direction. By simple switching of the currents, the conveying element 7′ can thus be displaced axially forward and backward and the mixed product MP conveyed.

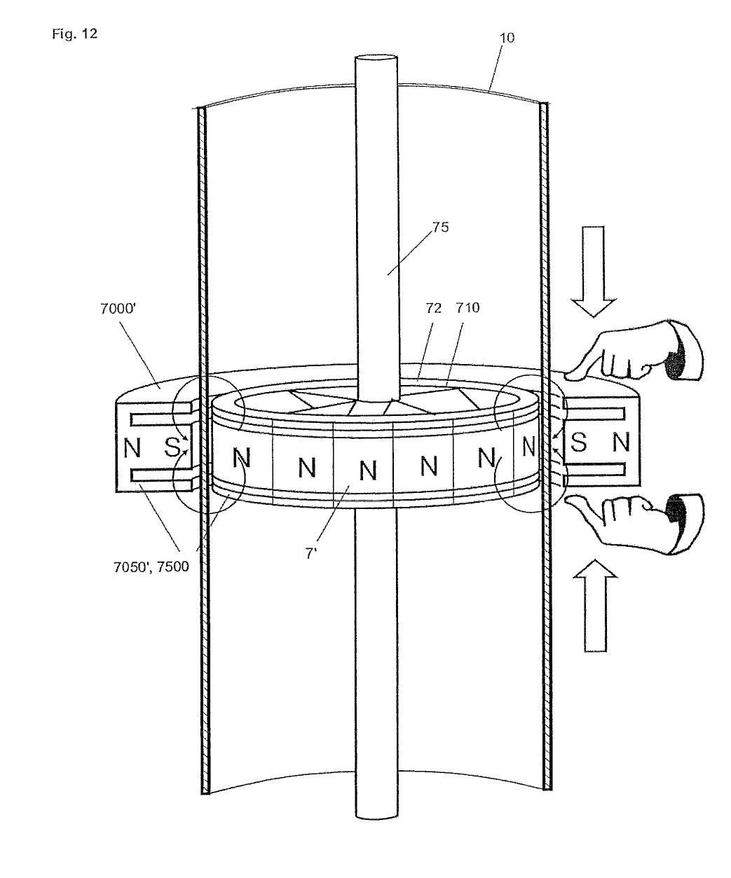

In FIG. 12 once again, an outer magnet ring 7000′ having permanent magnets is provided, which permanent magnets are aligned radially in the same direction, like the permanent magnets of the conveying element 7′, resulting in a coupling between the inner and the outer magnet ring 7′, 7000′. In order to improve the coupling between the magnet rings 7′, 7000′, a yoke elements 7050′, 7500 by means of which those poles of the permanent magnets which face away from one another are closely coupled are additionally provided. The outer magnet ring 7000′ therefore always floats at the height of the inner magnet ring 72, which however follows the movements of the outer magnet ring 7000′ and can thus be driven. The outer magnet ring 7000′ itself can be driven manually or by means of a motor.

The conveying element 7 or 7′ can therefore be rotated or axially displaced without mechanical intervention in the mixing chamber 100, by means of externally acting magnetic forces. The use of magnetically hard magnets outside the mixing chamber 100 for the formation of the magnetic field permits particularly advantageous contactless coupling of the conveying element 7, 7′ with an external drive unit 7 which has to expend energy only for driving the conveying element 77 or 77′ and not for generating the magnetic field.

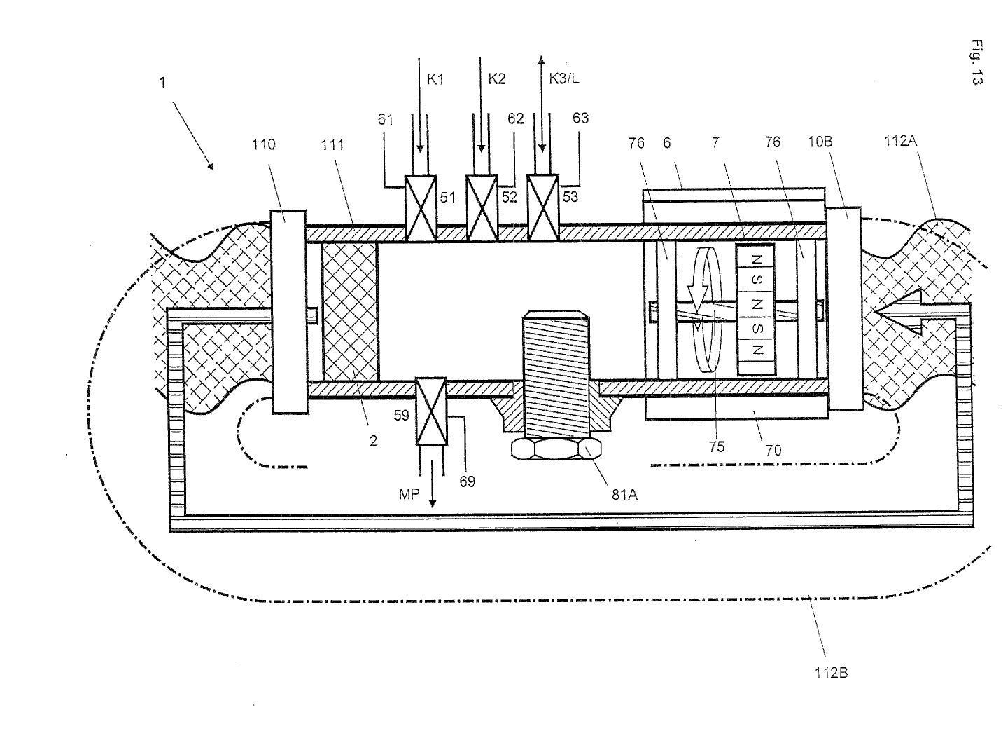

FIG. 13 shows a mixing device 1 according to the invention, comprising an annular mixing body 10 which has a straight tube element 111 and an additional flexible, resilient or rigid supplementary element 112A or 112B. All functional elements of the mixing device 1, namely the drive 7 with the conveying element 7, the optionally provided static mixer 2, the inlet and outlet valves 51, 52, 53, 59 and a metering body 81A, are provided in or on the straight tube element 111. The mixing device 1 according to the invention can be designed to be very compact in this form. If a hose is used as supplementary element 112A, the dimensions of the mixing device 1 are reduced, for storage and transport, to the dimensions of the straight tube element 111. Instead of a hose, it is also possible to use a hard resilient plastic tube or a light metal tube 112B, which is connected, for example, by means of two flange elements 110 to the straight tube element 111.

Owing to the simple design and the small dimensions, the mixing devices 1 shown in FIGS. 1 to 13 can also be flexibly used. The mixing devices 1 can be carried without problems to a place of use, optionally only assembled there and used.

The mixing device 1 according to the invention was described and shown in preferred configurations. On the basis of the teaching according to the invention, however, further competent configurations can be realized. In particular, it is possible to realize different forms of the mixing body 10 which have a self-contained mixing chamber 100 which, however, may have any desired shape, for example an annular or circular one. Furthermore, it is possible to use further drive and control mechanisms and of course also other valves which are connected, for example screwed or welded, to the mixing body 10 in a manner known to the person skilled in the art. Furthermore, it is of course also possible, if required, to choose the materials of the parts of the device.

The device is suitable for mixing a liquid component and at least one further liquid, viscous or pulverulent component (K1, K2, . . . ).

In particular, the device is suitable for mixing reactive compounds. In particular, the device is suitable for mixing a reactive component K2 into a liquid component K1, it being possible for the reactive component K2 either to react with the liquid component K1 or to react with itself under the influence of the liquid component K1. In these cases, it is often important to prevent an uncontrolled reaction. Such reactions are often to be encountered, for example, in polymerization or oligomerization reactions. In such reactions, it is often necessary to mix component K2 in as low a concentration as possible into the component K1.

The amount of the component K1 is preferably much higher than the components K2, K3 . . . . Typically, the ratio of the mass of K1 used to the mass of the mixed product is ≧0.5, in particular ≧0.6, preferably ≧0.7.

Thus, for example, low molecular weight polymers or oligomers can be prepared if the component K1 is hydrogen peroxide or a dispersion of an organic peroxide and the component K2 is a (meth)acrylate.

A further illustrative example for the use of the device according to the invention occurs in the preparation of adducts of polyisocyanates and polyamines. If the component K1 is a polyamine, e.g. a diamine of the formula H₂N—R′—NH₂, or a solution thereof in a solvent, into which the component K2 is metered and which is a polyisocyanate, e.g. a diisocyanate of the formula OCN—R″—NCO, in which R′ and R″ are in each case a divalent organic radical, an adduct of the formula (I) can be very efficiently prepared.

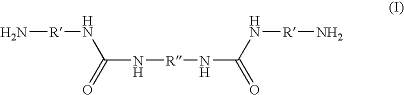

If, on the other hand, the component K1 is a polyisocyanate, e.g. a diisocyanate of the formula OCN—R″—NCO, to which the component K2 is metered and which is a polyamine, e.g. a diamine of the formula H₂N—R′—NH₂, or a solution thereof in a solvent, in which R′ and R″ are in each case a divalent organic radical, an adduct of the formula (II) can be very efficiently prepared.

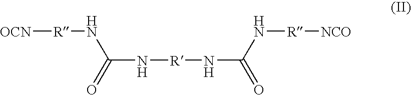

In both cases, the formation of higher molecular weight adducts can be greatly reduced.

A further illustrative example for the use of the device according to the invention is the preparation of molecules which are prepared via an intramolecular reaction, in particular with intramolecular ring formation. The reaction of a diol HO—R′—OH as component K2 with a carboxylic acid dichloride ClCO—R″—COCl as component K3 and a base in a solvent as component K1 to give an intramolecular diester (III) is shown schematically below as an example of this. The polyester formation (IV) (m>>1) can thus be reduced to a major extent.

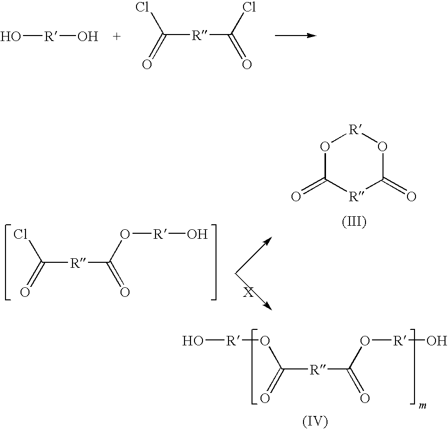

A preferred example of the use of the device according to the invention is for the preparation of aqueous silane solutions.

If the component K1 is water or an aqueous solution, into which at least one silane and/or at least one titanate as component K2 is metered, a homogeneous aqueous solution can be obtained by means of the device according to the invention without the formation of precipitates or turbidity, which are caused by higher oligomeric siloxanes or titanates.

In this preferred embodiment, the component K1 contains at least one acid in addition to water. The acid may be organic or inorganic. Organic acids are firstly carboxylic acids, in particular a carboxylic acid which is selected from the group consisting of formic, acetic, propionic, trifluoroacetic, oxalic, malonic, succinic, maleic, fumaric and citric acid, and amino acids, in particular aspartic acid and glutamic acid. Acids which have a pKₐ of from 4.0 to 5 are preferred. Owing to their pKₐ, such acids have an excellent buffer action in the pH range of 3.5 to 4.5 which is optimum for the present invention and results after the mixing of the components K1, K2, . . . . It is known that the chemist understands “pKₐ” to mean the negative logarithm to the base 10 of the acid dissociation constant Kₐ:pKₐ=−log₁₀Kₐ.

Acetic acid is preferred as the carboxylic acid. On the other hand, other suitable organic acids are those which contain a sulfur atom or phosphorus atom. Such organic acids are in particular organic sulfonic acids. Organic sulfonic acid is understood as meaning compounds which have an organic radical having carbon atoms and have at least one functional group —SO₃H. The aromatic sulfonic acid may be mononuclear or polynuclear and one or more sulfonic acid groups may be present. For example, this may be 1- or 2-naphthalenesulfonic acid, 1,5-naphthalenedisulfonic acid, benzenesulfonic acid or alkylbenzenesulfonic acids.

The component K1 may comprise further constituents which, however, can also be added separately as further components K3, K4, . . . . Examples of such additives are solvents, inorganic fillers, catalysts and stabilizers, dyes or pigments.

In the particularly preferred embodiment described, the component K2 comprises at least one silane.

In the present document, the term “organosilane” or “silane” for short designates compounds in which firstly at least one hydrolyzable group, in general two or three hydrolyzable groups, is or are bonded directly to the silicon atom and which secondly have at least one organic radical directly bonded to the silicon atom (via an Si—C bond) and have no Si—O—Si bonds. The silanes, or the silane groups thereof, have the property of hydrolyzing on contact with moisture. Organosilanols, i.e. organosilicon compounds containing one or more silanol groups (Si—OH groups) form thereby and, by subsequent condensation reactions, organosiloxanes, i.e. organosilicon compounds containing one or more siloxane groups (Si—O—Si groups).

In the present document, the term “titanate” designates compounds in which firstly at least one hydrolyzable group, in general two or three, typically four, hydrolyzable groups, is or are bonded directly to the titanium atom.

Terms such as “aminosilane”, “epoxysilane”, “alkylsilane”, “(meth)acrylatosilane”, “mercaptosilane” and “vinylsilanes” designate silanes which have the corresponding functional group, i.e. here an aminoalkylsilane, epoxyalkylsilane, alkylsilane, (meth)acryloyloxysilane, mercaptoalkylsilane and vinylsilane.

Suitable silanes are in particular aminosilanes, epoxysilanes, mercaptosilanes, (meth)acrylatosilane and alkylsilanes.

Firstly, aminosilanes of the formula (V) are particularly suitable as aminosilanes.

Secondly, those reaction products which are prepared by the reaction of aminosilanes of the formula (V) and an amino-reactive compound (ARC) are particularly suitable as aminosilanes, the amino-reactive compound containing at least one functional group which can react with a primary or secondary amino group and the aminosilane of the formula (V) having at least one secondary or primary amino group.

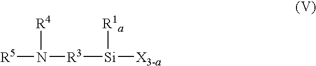

Here, R¹ is an alkyl group having 1 to 8 C atoms, preferably a methyl or an ethyl group. R¹ is preferably a methyl group.

Furthermore, X is a hydrolyzable group, in particular the group OR², R² being an alkyl group having 1 to 5 C atoms, preferably a methyl group or an ethyl group or an isopropyl group. R² is preferably a methyl group or an ethyl group.

Furthermore, R³ is a linear or branched alkylene group having 1 to 4 C atoms. R³ is preferably a propylene group.

Furthermore, R⁴ is H or a linear or branched alkylene group having 1 to 10 C atoms or a substituent of the formula (VI)

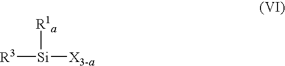

Furthermore, R⁵ is H or a linear or branched alkylene group having 1 to 10 C atoms or a linear or branched alkylene group having 1 to 10 C atoms with further heteroatoms or is a substituent of the formula (VI)

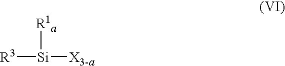

The radicals CH₂CH₂NH₂ and CH₂CH₂NHCH₂CH₂NH₂ are considered to be particularly advantageous radicals of a linear alkylene group having 1 to 10 C atoms with further heteroatoms R⁵.

Finally, the index a has a value 0, 1 or 2, in particular 0 or 1. a is preferably 0.

Examples of such aminosilanes of the formula (V) are 3-aminopropyl-trimethoxysilane, 3-aminopropyldimethoxymethylsilane, 3-amino-2-methylpropyltrimethoxysilane, 4-aminobutyltrimethoxysilane, 4-amino-butyldimethoxymethylsilane, 4-amino-3-methylbutyltrimethoxysilane, 4-amino-3,3-dimethylbutyltrimethoxysilane, 4-amino-3,3-dimethylbutyldimethoxymethyl-silane, 2-aminoethyltrimethoxysilane, 2-aminoethyldimethoxymethylsilane, aminomethyltrimethoxysilane, aminomethyldimethoxymethylsilane, aminomethylmethoxydimethylsilane, N-methyl-3-aminopropyl-trimethoxysilane, N-ethyl-3-aminopropyltrimethoxysilane, N-butyl-3-aminopropyltrimethoxysilane, N-cyclohexyl-3-aminopropyltrimethoxysilane, N-phenyl-3-aminopropyl-trimethoxysilane, N-methyl-3-amino-2-methylpropyltrimethoxysilane, N-ethyl-3-amino-2-methylpropyltrimethoxysilane, N-ethyl-3-aminopropyldimethoxy-methylsilane, N-phenyl-4-aminobutyltrimethoxysilane, N-phenylaminomethyl-dimethoxymethylsilane, N-cyclohexylaminomethyldimethoxymethylsilane, N-methylaminomethyldimethoxymethylsilane, N-ethylaminomethyldimethoxy-methylsilane, N-propylaminomethyldimethoxymethylsilane, N-butylamino-methyldimethoxymethylsilane; N-(2-aminoethyl)-3-aminopropyltrimethoxy-silane, bis(trimethoxysilylpropyl)amine, tris(trimethoxysilylpropyl)amine and the analogs thereof having ethoxy or isopropoxy groups instead of the methoxy groups on the silicon.

Preferred aminosilanes of the formula (V) are aminosilanes which are selected from the group consisting of aminosilanes of the formulae (VII), (VIII) and (IX).

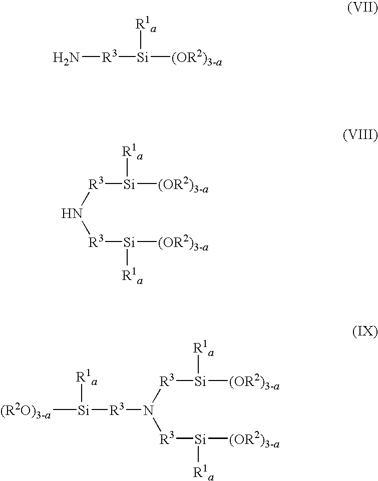

The most preferred aminosilanes of the formula (V) are the aminosilanes 3-aminopropyltrimethoxysilane, N-(2-aminoethyl)-3-amino-propyltrimethoxysilane, 3-[2-(2-aminoethylamino)ethylamino]propyltrimethoxy-silane, bis(trimethoxysilylpropyl)amine and tris(trimethoxysilylpropyl)amine.

In one embodiment, the aminosilane is a reaction product of an aminosilane of the formula (V), as has already been described above, and which has at least one secondary or primary amino group, with a compound (ARC) which has at least one functional group which can react with a primary or secondary amino group.

This functional group which can react with a primary or secondary amino group is preferably an epoxy group. However, other groups, such as, for example, isocyanate groups or activated double bonds, are also conceivable. Particularly suitable compounds having epoxy groups are epoxysilanes. Preferred compounds (ARC) which can react with the aminosilane of the formula (V) having at least one secondary or primary amino group are epoxysilanes of the formula (X)

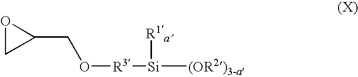

Here, R^{1′} is an alkyl group having 1 to 8 C atoms, preferably a methyl or an ethyl group. R^{2′} is an alkyl group having 1 to 5 C atoms. Furthermore, R^{3′} is a linear or branched alkylene group having 1 to 4 C atoms and a′ is 0, 1 or 2, in particular 0 or 1.

R^{1′} is in particular a methyl group. R^{2′} is preferably a methyl group or an ethyl group or an isopropyl group. R^{2′} is particularly preferably a methyl group or an ethyl group. R^{3′} is preferably propylene. The index a′ is preferably 0.

Epoxysilanes are, for example, 2-(3,4-epoxycyclohexyl)ethyltri-methoxysilane, 2-(3,4-epoxycyclohexyl)ethyltriethoxysilane, 3-glycidyloxy-propyltriethoxysilane and 3-glycidyloxypropyltrimethoxysilane.

Preferred epoxysilanes are 3-glycidyloxypropyltriethoxysilane and 3-glycidyloxypropyltrimethoxysilane. The most preferred epoxysilane is 3-glycidyloxypropyltrimethoxysilane.

The aminosilane of the formula (V) which is used for the reaction product is, in addition to N-(2-aminoethyl)-3-aminopropyltrimethoxysilane and N-(2-aminoethyl)-3-aminopropyltriethoxysilane, preferably N-(2-aminoethyl)-3-aminopropyltrimethoxysilane, in particular aminosilanes of the formula (VII) or (VIII), in particular 3-aminopropyltrimethoxysilane, bis(trimethoxysilylpropyl)-amine, 3-aminopropyltriethoxysilane and bis(triethoxysilylpropyl)amine. 3-Aminopropyltrimethoxysilane and bis(trimethoxysilylpropyl)amine are preferred.

Depending on the stoichiometry of the aminosilane of the formula (V) and the amine-reactive compound (ARC), the reaction product may or may not also have primary or secondary amino groups.

Examples of such reaction products are compounds of the formulae (XI), (XII), (XIII), (XIV), (XV) and (XVI).

The compounds of the formulae (XI), (XII) and (XIII) are obtained from the reaction of N-(2-aminoethyl)-3-aminopropyltrimethoxysilane and 3-glycidyl-oxypropyltrimethoxysilane.

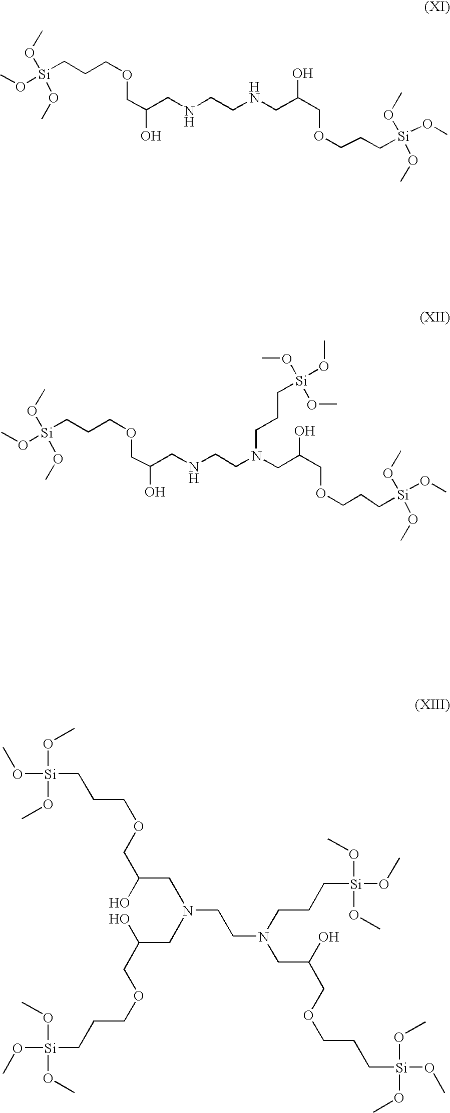

The compounds of the formulae (XIV) and (XV) are obtained from the reaction of 3-aminopropyltrimethoxysilane and 3-glycidyloxypropyltri-methoxysilane.

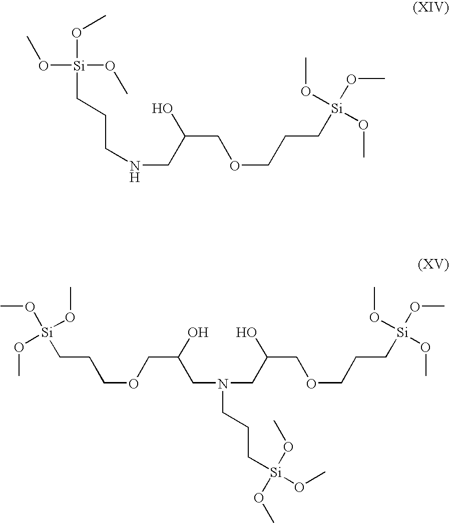

The compound of the formula (XVI) is obtained from the reaction of bis(trimethoxysilylpropyl)amine and 3-glycidyloxypropyltrimethoxysilane.

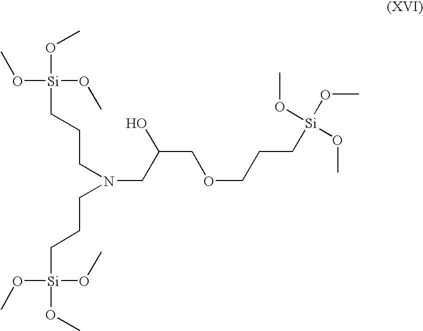

Of course, further intermolecular and intramolecular reaction products, as are obtainable by ring formations and transesterification reactions, are also possible.

Examples of amine-reactive compounds (ARC) having activated double bonds are, for example, α,β-unsaturated compounds, in particular maleic acid diesters, fumaric acid diesters, citraconic acid diesters, acrylic acid esters, methacrylic acid esters, cinnamic acid esters, itaconic acid diesters, vinylphosphonic acid diesters, aryl vinylsulfonates, vinyl sulfones, vinylnitriles, 1-nitroethylenes or Knoevenagel condensates, such as, for example, those of malonic acid diesters and aldehydes, such as formaldehyde, acetaldehyde or benzaldehyde. Such amine-reactive compounds form Michael adducts in which the amine has undergone addition at the double bond. Examples of such reaction products are Michael adducts of 3-aminopropyltrimethoxysilane, 3-aminopropyldimethoxymethylsilane, 4-amino-3,3-dimethylbutyltrimethoxy-silane, 4-amino-3,3-dimethylbutyldimethoxymethylsilane, aminomethyl-trimethoxysilane or aminomethyldimethoxymethylsilane with dimethyl, diethyl or dibutyl maleate, tetrahydrofurfuryl, isobornyl, hexyl, lauryl, stearyl, 2-hydroxyethyl or 3-hydroxypropyl acrylate, dimethyl, diethyl or dibutyl phosphonate, acrylonitrile, 2-pentenenitrile, fumaronitrile or β-nitrostyrene, and the analogs of said aminosilanes having ethoxy groups instead of methoxy groups on the silicon. In particular, the Michael adduct diethyl N-(3-trimethoxysilylpropyl)aminosuccinate may be mentioned.

Examples of amine-reactive compounds (ARC) having isocyanate groups are isocyanatosilanes or polyisocyanates. 3-Isocyanatopropyl-trimethoxysilane and 3-isocyanatopropyltriethoxysilane may be mentioned in particular as isocyanatosilane. Polyisocyanates are, for example, 2,4- and 2,6-toluoylene diisocyanate (TDI) and any desired mixtures of these isomers, 4,4′-, 2,4′- and 2,2′-diphenylmethane diisocyanate (MDI) and any desired mixtures of these and further isomers, 1,3- and 1,4-phenylene diisocyanate, 2,3,5,6-tetramethyl-1,4-diisocyanatobenzene, 1,6-hexamethylene diisocyanate (HDI), 2-methylpentamethylene 1,5-diisocyanate, 2,2,4- and 2,4,4-trimethyl-1,6-hexa-methylene diisocyanate (TMDI), 1,12-dodecamethylene diisocyanate, cyclohexane 1,3- and 1,4-diisocyanate and any desired mixtures of these isomers, 1-isocyanato-3,3,5-trimethyl-5-isocyanatomethylcyclohexane (=iso-phorone diisocyanate or IPDI), perhydro-2,4′- and -4,4′-diphenylmethane diiso-cyanate (HMDI), 1,4-diisocyanato-2,2,6-trimethylcyclohexane (TMCDI), m- and p-xylylene diisocyanate (XDI), 1,3- and 1,4-tetramethylxylylene diisocyanate (TMXDI), 1,3- and 1,4-bis(isocyanatomethyl)cyclohexane, oligomers of the abovementioned polyisocyanates and any desired mixtures of the abovementioned polyisocyanates. MDI, TDI, HDI and IPDI and the biurets and isocyanurates thereof are preferred.

If the silane is an epoxysilane, the epoxysilanes as described above as amine-reactive compounds (ARC) are to be preferred.

3-Mercaptopropyltrimethoxysilane and 3-mercaptopropyltriethoxysilane may be mentioned by way of example as mercaptosilane.

3-Methacryloyloxypropyltrimethoxysilane and 3-methacryloyloxypropyl-triethoxysilane may be mentioned by way of example as (meth)acrylatosilane.

If the silane is an alkylsilane, the silanes having C₁-C₆-alkyl radicals may be mentioned in particular, such as, for example, methyltrimethoxysilane, ethyltrimethoxysilane and butyltrimethoxysilane.

The component K2 may contain further constituents. These further constituents can, however, also be added separately as components K3, K4 etc. Such further constituents are in particular surfactants, solvents, inorganic fillers, catalysts and stabilizers, dyes or pigments.

Surfactants which may be used are natural or synthetic substances which, in solutions, reduce the surface tension of the water or other liquids. Anionic, cationic, nonionic or ampholytic surfactants or mixtures thereof may be used as surfactants, also referred to as wetting agents. A ratio of silane to surfactant of from 5:1 to 1:2 is preferred. The optimum ratio of silane to surfactant, in particular for aminosilanes as silanes, is a value of from 3:1 to 2:3. It is preferable if the component K2 has not less than 33% by weight, in particular not less than 40% by weight, of silane. It is advantageous if the component K2 has not more than 1% by weight, in particular not more than 0.5% by weight, of water. Particularly preferably, the component K2 substantially comprises only silane and surfactant. Here, “substantially” is understood as meaning that the total weight of silane and surfactant is more than 90% by weight, in particular more than 95% by weight, preferably more than 99% by weight, based on the weight of the component K2.

The invention also relates to a process for mixing at least one liquid component and at least one further liquid, viscous or pulverulent component (K1, K2, . . . ) by means of a device that was described above.

It has been found that in this way thorough mixing is permitted so that only low local concentrations of reactive compounds occur if the components K1 and K2 come into contact with one another at least at the time of reaction. The formation of relatively high molecular weight species can thus be prevented or greatly reduced so that substantially low molecular weight compounds are formed.

Furthermore, these desired low molecular weight compounds can be obtained in relatively high concentration without having to separate off solvent in a large amount.

Devices according to the invention which firstly have a strong circulation of the component K1 or of the mixed product in the ring line and in which turbulent flows occur during or immediately after the site of introduction of the respective components, in particular of component K2, are therefore particularly preferred. The use of static mixers 2 or of the conveying element 7,7′,7″, in particular immediately after or in the vicinity of the inlet openings 101, 102, 103 or the metering chamber 31 in the direction of flow, is therefore preferred. In order to achieve mixing which is as efficient as possible, it may be advantageous if a plurality of conveying elements 7,7′,7″ and/or static mixers 2 are used. The components are preferably metered in slowly. This can be effected by continuous addition or by pulsed addition. The metering rate must be tailored to the reactivity of the components, the flow rate, the concentration, the viscosity and turbulence in the mixing chamber, in particular during or after the entry site of the components into the mixing chamber.

Typically, the process is effected as follows. The mixing chamber 100 is filled with the component K1. The component K2 is then metered in with circulation of the component K1 by means of conveying elements 7,7′,7″ so that a mixture of K1 and K2 or reaction products formed therefrom is or are present in the chamber and is or are likewise circulated. After the end of the metering in of component K2, circulation is continued until the desired mixed product is present in the desired quality. It may be advantageous if the mixing chamber 100 is now full. For example, all possible foam formation is not present or is greatly suppressed in a completely filled mixing chamber 100. It may also be advantageous if the mixing chamber 100 is now not completely full of liquid and, for example, air or an inert gas, such as nitrogen, is still present in the mixing chamber. Such a fill may be advantageous, for example, with respect to better mixing.

After the desired mixed product is present in the desired quality, said mixed product is removed from the device through an outlet opening 109. The device can then be used for further mixing processes. It may be advantageous if the device, after emptying of the mixed product from the device, a cleaning process of the device is effected. Thus, the mixing chamber can be filled and circulated with a solvent or the component K1 and then emptied and if necessary dried by means of air or gas. Such cleaning processes can also be carried out automatically, for example after a certain number of mixing and emptying processes or after certain time intervals.

### LIST OF REFERENCES

[1] WO 02/32562 A1
[2] U.S. Pat. No. 4,191,480
[3] U.S. Pat. No. 4,264,212
[4] U.S. Pat. No. 5,240,327
[5] U.S. Pat. No. 6,024,481
[6] US 2004/0190372 A1

### LIST OF REFERENCE NUMERALS

1 Mixing device
10 Mixing body
100 Mixing chamber
1000 Metering chamber
1030 Drum chamber
1035, 1036 Bounding plates
101, 102, 103 Inlet openings
105 Overflow opening
1050 Overflow opening or vent opening
109 Outlet opening
110 Connecting element
111 First tube element
112A, 112B, 112C Second tube element
1120C Extensible element, bellows
2; 2a, 2b Static mixer
3 Metering drum
31 Metering chamber in the metering drum 3
32 Shaft of the metering drum 3
4 Graduated rod, level indicator, graduated glass
40 Scale
5000 Vent and/or overflow screw
5001 Air channel in the vent screw 5000
500 Valve body with bore
501 Lateral outlet opening
502 Bore in the valve body
5031 Resilient element or hose
5032 Resilient element or cap
50321 Passage in the cap 524
5033 Resilient element or spring
5034 Ball
504 End element
51, . . . , 59 Mechanical valves
51′, . . . , 59′ Electromechanical valves
52d, 53d Valve in the metering chamber 1000
510 Pressure relief valve
590 Shaft with wheel
591 Bore
6 Control unit
61, 62, . . . Lines connected to the control unit 6
7,7′,7″ Conveying element
70 Drive unit
700 Coil packets
7000, 7000′ Outer magnet ring, magnet holder
71, 710 Rigid or rotatably mounted wing elements
711 Shafts of the rotatably mounted wing elements 710
72 (Inner) magnet ring
75 Shaft
750 Crankshaft
76 Bearing element for the shaft 75
79 Switch
8 Expansion vessels
800 Measuring sensor
81A, 81B Metering screw, metering piston
900, 900′, 901, 901′ Line, air line, gas line, flushing line
91, 92, . . . Feed lines for the mixing chamber 100
91′, 92′ Feed lines for the metering chamber 1000
99 Outlet line
K1, K2, . . . Mixing components
L Air, gas, nitrogen
MP Mixed product

1. A device for mixing a liquid first component and at least one liquid, viscous or pulverulent further component, the device comprising:
a mixing body:
a mixing chamber provided inside the mixing body, which can be used to mix the first component and the at least one further component, to create a mixed product and the mixed product can be removed from the mixing chamber after the mixing process has been carried out, wherein
the mixing body is a self-contained, annular, tube system whose interior forms the mixing chamber through which the mixed product can be transported cyclically by a conveying element;
a plurality of closable inlet openings for feeding in the at least one further component; and
at least one closable outlet for removing the mixed product from the mixing body.

2. The device as claimed in claim 1, further comprising a conveying element that acts from an outside on the mixing body by a force, the conveying element is rotatable by a shaft, and the conveying element allows the mixed product to pass through the mixing chamber unhindered only in one direction, wherein
the conveying element is held so that the conveying element is displaceable forward and backward along the shaft, and the conveying element or the shaft being capable of being driven by a mechanical, electromechanical or magnetic drive.

3. The device as claimed in claim 1, further comprising at least one static mixer, through which the mixed product passes cyclically during the mixing process, and the at least one static mixer is arranged in the mixing chamber close to the plurality of closable inlet openings in a direction of flow, wherein
the at least one static mixer being coordinated with the plurality of closable inlet openings for introducing the at least one further component respectively.

4. The device as claimed in claim 1, wherein:
a) at least one overflow opening is provided in the mixing body, from which overflow of the mixed product or the still unmixed first component can emerge, in an adjustable volume; and/or in that
b) at least one metering body is provided in the mixing body, and the at least one metering body can be displaced out of the mixing chamber, by a selectable volume such that a free volume fraction results in the mixing chamber and the free volume fraction can be filled by at least one further component; and/or in that
c) a metering chamber connected to the mixing chamber, a certain volume of the at least one further component can be introduced with the aid of a measuring device and/or a moving piston and can be transferred to the mixing chamber by feeding a gaseous medium or driving the piston into the mixing chamber; and/or in that
d) a metering drum provided with a metering chamber is rotatably mounted inside a closed drum chamber adjacent to the mixing body in such a way that the metering chamber opens on both sides, in a first position, the metering chamber is connected in a tightly sealed manner to a feed line and/or to a feed line and a discharge line of the further component and, in a second position, the metering chamber projects in a opened state into the mixing chamber.

5. The device as claimed in claim 4, wherein the metering drum is rotatably mounted in such a way that, in a third position, the metering chamber is connected to a flushing line and/or, in a fourth position, the metering chamber is connected to a gas line, such that the metering chamber can be flushed, blown out and dried.

6. The device as claimed in claim 4, wherein the adjustable volume of the mixed product or the first component emerging through the at least one overflow opening is limited by an expansion vessel having an adjustable volume, and the expansion vessel includes a measuring sensor that senses a level of the mixed product or the first component that has flowed through the at least one overflow opening.

7. The device as claimed in claim 1, wherein one of the plurality of closable inlet openings serves for feeding in and/or discharging a gaseous medium that is under pressure from a compressor or a compressed gas cylinder, and the gaseous medium can be introduced into the mixing chamber or discharged therefrom.

8. The device as claimed in claim 1, wherein at least one of the plurality of closable inlet openings, the at least one closable outlet and/or at least one overflow opening is closed by a manually, electrically, pneumatically or hydraulically controlled valve and/or a mechanical valve that projects into the mixing chamber and connects to the plurality of closable inlet openings.

9. The device as claimed in claim 1, wherein the mixing body is composed of one or more tube system parts detachably connected to one another, such as a first straight and a second curved tube element, at least one straight first tube element being provided with the plurality of closable inlet openings, the at least one closable outlet and/or at least one overflow opening, and a static mixer, a at least one metering body and/or a conveying element being connected to at least one flexible, hard resilient or rigid, second tube element.

10. The device as claimed in claim 9, wherein the mixing body or the one or more tube system parts consist of material such as plastic or metal that is inert to the first and further components to be mixed in the mixing chamber.

11. The device as claimed in claim 1, wherein a control unit is provided with a control program and the control unit controls at least one of valves, a drive unit for a conveying element and/or at least one pump that feeds in the first and/or further component, as a function of signals output by a measuring sensor.

12. The device as claimed in claim 1, wherein a conveying element is rotatably or displaceably mounted with a shaft and is provided with permanent magnets, which are coupled to permanent magnets of a annular magnet holder rotatably or displaceably mounted outside the mixing body or coupled to a magnetic field, which can be generated by means of coils.

13. The device as claimed in claim 1, wherein a rotatably mounted conveying element including conveying elements which are rigidly held, or the rotatably mounted conveying element is mounted so as to be axially displaceable and includes conveying elements, which are held rotatably or displaceably between a first and a second position such that the conveying elements assume as a function of a direction of movement by the mixed product in order to transport the mixed product or to allow the mixed product to pass through.

14. The device as claimed in claim 8, wherein the valves include a valve body with a through-bore, which can be closed with a ball mounted with a resilient element, or the valves include a valve body with a bore and at least one outlet opening against, which a hose-like resilient element presses, or the valves include a valve body with a through-bore that is covered with a resilient element, which has a passage that opens under an action of pressure.

15. The device as claimed in claim 1, wherein the at least one further component is a component that is reactive with the first component, or the first component initiates a reaction of the at least one further component with the at least one further component.

16. The device as claimed in claim 15, wherein the first component is or contains water and the at least one further component is a silane.

17. The device as claimed in claim 16, wherein the silane is or contains an aminosilane, of a formula (V) or a reaction product of the formula (V), which has at least one secondary or primary amino group, with a compound (ARC) with at least one functional group, which can react with a primary or secondary amino group 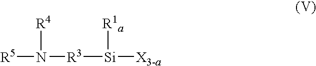
in which
R¹ is an alkyl group having 1 to 8 C atoms, and the alkyl group is a methyl or an ethyl group;
X is a hydrolyzable group, and the hydrolysable group is a group OR², in which R² is an alkyl group having 1 to 5 C atoms and the alkyl group is a methyl group or an ethyl group, or an isopropyl group and the isopropyl group is a methyl group or an ethyl group;
R³ is a linear or branched alkylene group having 1 to 4 C atoms, the alkylene group is a propylene group;
R⁴ is H or a linear or branched alkylene group having 1 to 10 C atoms or a substituent of formula (VI) 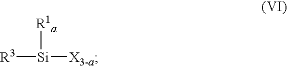
R⁵ is H or a linear or branched alkylene group having 1 to 10 C atoms or a linear or branched alkylene group having 1 to 10 C atoms with further heteroatoms or a substituent of a formula (VI) 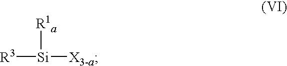
and a has a value 0, 1 or 2.

18. A process for mixing the liquid first component and the at least one liquid, viscous or pulverulent further component using the device as claimed in claim 1.

19. A process for preparation of low molecular weight reaction products using the device as claimed in claim 1 and the at least one further component, which is reactive with the first component or reacts with the at least one further component through an influence of the first component.
